(19) United States
(12) Patent Application Publication
(10) Pub. No.: US 2006/0046701 A1
(43) Pub. Date: Mar. 2, 2006

(54) Method and mobile communication terminal for answering silently a call

(75) Inventors: Paul Anderson, Hong Kong (HK); Wong Guy Hung, Kowloon (HK); Choi Hsiao-Feng, Hong Kong (HK); Jamie Yung, Kowloon (HK)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/928,607

(22) Filed: Aug. 27, 2004

(51) Int. Cl. H04M 11/10

(52) U.S. Cl. 455/414.4; 455/418

(57) ABSTRACT

The invention relates in general to the field of mobile devices e.g. mobile communication terminals and a method for answering silently a call. According to the invention a call is answered silently with a mobile communication terminal in such a way that a receiver is kept on so that a user of the mobile communication terminal hears the caller, the user doesn't need to speak, when answering silently, and further a pre-recorded voice tag corresponding to a keyboard symbol of the mobile communication terminal selected by the user during the call is played to the caller as a response. Moreover, according to an embodiment of the invention a microphone of the mobile communication terminal is also switched off, and keyboard symbols and corresponding tag names are displayed in the display of the mobile communication terminal.

### TECHNICAL FIELD OF THE INVENTION

This invention relates in general to the field of mobile devices e.g. mobile communication terminals and a method and mobile communication terminal for answering silently a call.

### BACKGROUND OF THE INVENTION

Mobile communication terminals are nowadays very common and they are more often continuously carried along by the user including a situation where the user can't answer an incoming voice telephone call and give an audible reply to the other party, such as in a confidential meeting. The incoming call in the middle of a meeting is quite irritating because the user sees the incoming call but doesn't know if it is important or not. Therefore there is a huge temptation to answer the call either without leaving the meeting or stepping out of the meeting. There is however a problem because both these methods disturb the course of the meeting and are therefore more or less incorrect.

Different kinds of solutions to overcome this problem are, however, known from prior art. One method is to switch a mobile phone to a silent mode, whereupon incoming calls don't disturb the user. Another way is to send SMS messages (Short Message Service). U.S. Pat. No. 6,301,338 teaches another method, where a telephone answering function is adapted to operate in different ways according to the number of the calling party. According to U.S. Pat. No. 6,301,338, in response to the incoming call, the communication device identifies the caller on the basis of an identification information included within the incoming call and sends a reply according to a selection made by the user, or directs the incoming call to another answering service, where said reply is one of the following: a voice message, an e-mail message, a facsimile, an SMS message in the form of a character string.

There are, however, some problems also with the solutions known from the prior art, namely, in using them the user can't hear and/or communicate audibly and/or interactively with the other party, but may know who the caller is based on the CLI (Caller Line Identity). The user can just forward all voice calls to voice mail, only accept SMS, or frequently steps out of a meeting for unimportant calls. The problem in the known prior art still is how to accept a telephone call and give an audible reply to the other party more or less interactively without needing to speak for example in a meeting.

### SUMMARY OF THE INVENTION

An object of the present invention is to provide a method and a mobile communication terminal, by means of which a user can accept a telephone call and give an audible and interactive reply to the other party (caller) without needing to speak and moreover by means of which the user can avoid the caller being able to hear sounds directly coming from the user's location even if the user gives an audible reply.

The object of the invention will be achieved by pre-recording different kinds of voice tags to a memory of a mobile communication terminal in such a way, that when the user receives a call, he/she can select a voice tag mode and select a pre-recorded voice tag from the memory of the mobile communication terminal to be played as a response to the caller, where in the voice tag mode the user can hear the caller, and thereby select an appropriate pre-recorded “answer” as a reply to the caller's question. Moreover in the voice tag mode a microphone of the user's mobile communication terminal is switched off, whereupon the caller can neither hear the user directly nor sounds of the user's environment, but only the pre-recorded voice tags.

The present invention relates to a method for answering silently a call with a mobile communication terminal, wherein the method comprises keeping a receiver on so that a user of the mobile communication terminal hears the caller, and the method further comprises playing a pre-recorded voice tag as a response to the caller, when the user during the call selects the pre-recorded voice tag to be played using a keyboard symbol of the mobile communication terminal corresponding the pre-recorded voice tag.

The present invention further relates to a mobile communication terminal for answering silently a call, wherein in a silent mode the mobile communication terminal is adapted to keep a receiver on so that a user of the mobile communication terminal hears the caller, and further adapted to play a pre-recorded voice tag as a response to the caller, when the user during the call selects the pre-recorded voice tag to be played using a keyboard symbol of the mobile communication terminal corresponding the pre-recorded voice tag.

Furthermore the present invention relates also to a computer program for answering silently a call with a mobile communication terminal, wherein the computer program comprises a play code, which is adapted in a silent mode to play a pre-recorded voice tag as a response to the caller, when said pre-recorded voice tag corresponding to a keyboard symbol of the mobile communication terminal is selected by the user during the call and the play code is run on the terminal.

According to a first embodiment of the invention a mobile communication terminal user can pre-record up to ten voice tags corresponding to number keys on the mobile communication terminal. Then when he/she receives a call during a meeting, for example, he/she can select a voice tag mode. In voice tag mode the user can hear the other party, but the other party cannot hear him directly. The user can however respond interactively with a voice by pressing number keys, which will play voice tags instead of the usual DTMF tones (Dual Tone Multi Frequency). Examples of voice tags used by the user might be “hello”, “yes”, “no”, “I'm in a meeting, what do you want to say?”, and “bye bye”, for example. The mobile communication terminal display will advantageously show a list of numbers and the corresponding voice tag name so the user doesn't need to remember which number is which tag.

The receiver can be a built in speaker, a speaker phone device, or an extension of either, such as a wired or wireless earpiece or headset.

According to an embodiment of the present invention the mobile communication terminal is arranged to record for example ten voice tags of a few seconds duration each, and to give them names, by menu selection, when the mobile communication terminal is not in a call. When the mobile communication terminal receives a call, the invention offers another answering option in addition to the current, “answer”, “reject”, & “speakerphone” choice, namely the pre-recorded voice tags. If the voice tag mode is selected to answer a call, the display will advantageously show a list from 0 to 9 with tag names, for example. Pressing a number button during a call the voice tag answer mode plays the corresponding voice tag instead of a DTMF tone.

According to the invention the user can use pre-recorded voice tags to give a very simple answer to the caller, especially when the call is not so important. If the call is very important, the user can step out of the meeting in confidence if this is really necessary.

The present invention offers clear advantages over the prior art solutions. According to the invention the pre-defined voice tags allow the user to still use a mobile phone for receiving voice calls even when he/she is not supposed to speak. Moreover it should be noted that not everyone likes to leave voice mail message, or type in SMS messages, and thus important calls and contacts may be missed. The invention allows, however, the user to make a more informed decision if and when to leave a meeting to take an urgent voice call.

### BRIEF DESCRIPTION OF THE DRAWINGS

Next the invention will be described in greater detail with reference to exemplary embodiments in accordance with the accompanying drawings, in which:

FIG. 1 illustrates a flow diagram of an exemplary method for recording a voice tag according to an advantageous embodiment of the invention,

FIG. 2 illustrates a flow diagram of an exemplary method for answering a call using a voice tag mode according to an advantageous embodiment of the invention,

FIG. 3A illustrates an exemplary mobile communication terminal according to an advantageous embodiment of the invention, when the mobile communication terminal receives a call,

FIG. 3B illustrates an exemplary mobile communication terminal according to an advantageous embodiment of the invention, when the call is answered using a voice tag mode, and

FIG. 4 illustrates a block diagram of an exemplary computer program for realizing a voice tag mode in a mobile communication terminal according to an advantageous embodiment of the invention.

### DETAILED DESCRIPTION

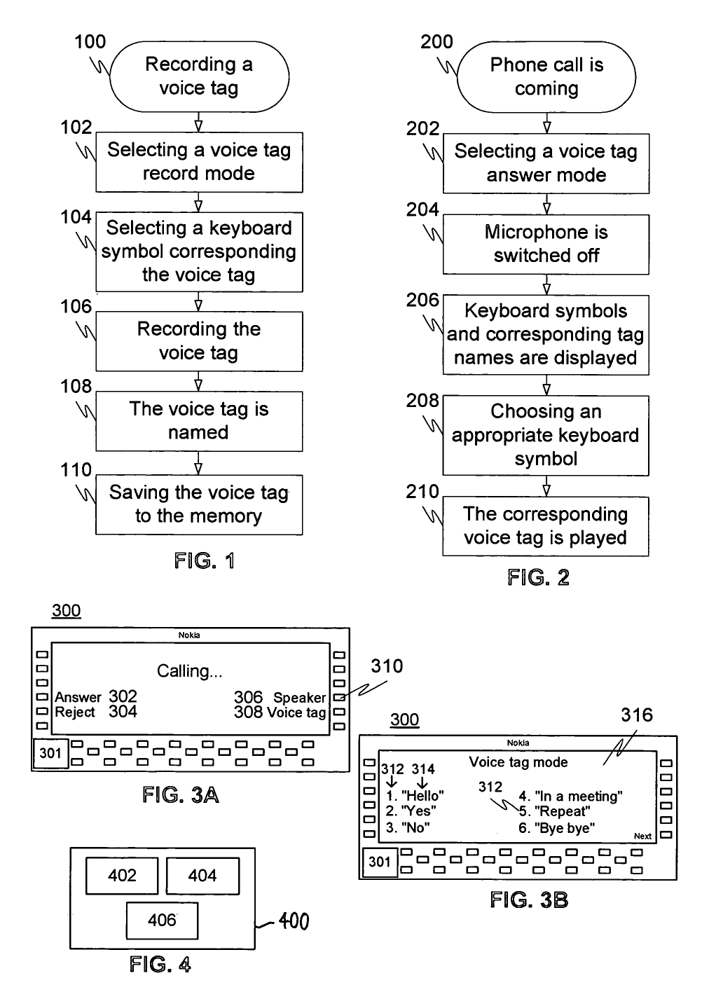

FIG. 1 illustrates a flow diagram of an exemplary method 100 for recording a voice tag according to an advantageous embodiment of the invention, where at first a voice tag record mode is selected at step 102. At step 104 keyboard symbol is selected corresponding the voice tag to be recorded. A keyboard symbol is most advantageously number, such as 0, 1, 2 . . . , but it is clear that it can also be a letter, such as A, B, C . . . , but also a special character, like @, and # can be used.

After selecting the keyboard symbol the user can record the voice tag by dictating a message, such as ““I'm in a meeting, what do you want to say?” at step 106 and at step 108 to write a name for the message to be displayed with the corresponding keyboard symbol, like: 1=““I'm in a meeting, what do you want to say?”. When the voice message is recorded, named and corresponding keyboard symbol selected, the recorded voice tag is advantageously saved at step 110 to voice data storage medium in a mobile communication terminal.

FIG. 2 illustrates a flow diagram of an exemplary method 200 for answering a call using a voice tag mode according to an advantageous embodiment of the invention, where at first the voice tag mode is selected at step 202. When the voice tag mode is selected, the microphone of the mobile communication terminal is advantageously switched off at step 204, whereupon the caller can't hear direct the user of the mobile communication terminal or any sounds directly coming from the user's location or environment.

The mobile communication terminal is advantageously adapted to display keyboard symbols and corresponding stored tag names in the display at step 206 when the voice tag mode is selected, whereupon the user doesn't need to remember which keyboard symbol, such as number, corresponds to which voice tag. At step 208 the user can select an appropriate keyboard symbol, whereupon at step 210 the corresponding voice tag is played from the memory of the mobile communication terminal to the caller instead of a DTMF tone.

Of course it should be realized that the steps of FIGS. 1 and 2 need not be carried out in the exact sequence shown but variations are possible. Moreover, it should be realized that steps may be added or selected steps deleted while still carrying out the basic idea.

FIG. 3A illustrates an exemplary mobile communication terminal 300 according to an advantageous embodiment of the invention. In FIG. 3A the mobile communication terminal is receiving a call, whereupon it advantageously is adapted to display alternatives to the user either to answer normally 302, reject 304, answer in a speakerphone mode 306 or answer in a voice tag mode 308. If the user wants to answer in the voice tag mode, he/she just presses an appropriate voice tag button 310, whereupon the mobile communication terminal is advantageously adapted to run at least one of the steps illustrated in FIG. 2.

Further the mobile communication terminal 300 comprises also a voice data storage medium 301 to which the voice tags are stored and from which they are played to the caller, when the user presses an appropriate keyboard symbol.

FIG. 3B illustrates an exemplary mobile communication terminal 300 according to an advantageous embodiment of the invention, when the call is answered using a voice tag mode. In the voice tag mode the mobile communication terminal is advantageously adapted to display keyboard symbols 312 and corresponding stored tag names 314 in the display 316. The keyboard symbols is most advantageously numbers, whereupon the user can just press corresponding number, such as 4, which tag name may be “In a meeting” named by the user at step 108 in FIG. 1. When pressing the number 4, the mobile communication terminal is adapted to play corresponding pre-recorded voice tag, which is in this example “I'm in a meeting, what do you want to say?”.

FIG. 4 illustrates a block diagram of an exemplary computer program 400 for realizing a voice tag mode in a mobile communication terminal according to an advantageous embodiment of the invention, where the computer program comprises an answer code 402, which is adapted to switch off a microphone of the mobile communication terminal, when the answer code is run on the mobile communication terminal. Further the answer code 402 is adapted to display keyboard symbols and corresponding tag names in the display of the mobile communication terminal, when it is run. Still the computer program 400 comprises a play code 404, which is adapted to play a pre-recorded voice tag from a voice data storage medium in the mobile communication terminal to the caller, when said pre-recorded voice tag is selected by an appropriate keyboard symbol and the code 404 is run on the terminal 300.

The codes 402, 404 are run on the mobile communication terminal 300 advantageously when a call is coming and the voice tag mode is selected for the answer mode.

Furthermore the computer program 400 comprises according to an embodiment of the invention a recording code 406, which is adapted to record a voice tag dictated by the user to the voice data storage medium in the mobile communication terminal, when the code 406 is run on the mobile communication terminal. Further the code 406 is adapted to connect a tag name given by the user to the recorded voice tag, when said code is run.

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims.

Especially it should be noted that the keyboard symbols are most advantageously number buttons of the mobile communication terminal, but may also be other buttons or symbols, such as symbols displayed on a touch screen, for example. Moreover it should be noted that the mobile communication terminal can be adapted to display also a menu, where the user can select an appropriate voice tag to be played to the caller as an audible response.

1. A mobile communication terminal for answering silently a call, wherein in a silent mode the mobile communication terminal is adapted to keep a receiver on so that a user of the mobile communication terminal hears the caller, and further adapted to play a pre-recorded voice tag as a response to the caller, when the user during the call selects the pre-recorded voice tag to be played using a keyboard symbol of the mobile communication terminal corresponding the pre-recorded voice tag.

2. A mobile communication terminal according to claim 1, wherein the mobile communication terminal is further adapted to display at least one keyboard symbol and the corresponding voice tag name.

3. A mobile communication terminal according to claim 1, wherein the mobile communication terminal is further adapted to switch off a microphone of the mobile communication terminal.

4. A mobile communication terminal according to claim 1, wherein the mobile communication terminal is further adapted to record a voice tag dictated by the user to a voice data storage medium in the mobile communication terminal.

5. A mobile communication terminal according to claim 1, wherein the mobile communication terminal is further adapted to connect a tag name with an appropriate voice tag.

6. A mobile communication terminal according to claim 1, wherein the keyboard symbol is at least one of the following: a number, letter or special key of the mobile communication terminal, or a symbol displayed on a touch screen of the mobile communication terminal, or both.

7. A method for answering silently a call with a mobile communication terminal, wherein the method comprising keeping a receiver on so that a user of the mobile communication terminal hears the caller, and the method further comprising playing a pre-recorded voice tag as a response to the caller, when the user during the call selects the pre-recorded voice tag to be played using a keyboard symbol of the mobile communication terminal corresponding the pre-recorded voice tag.

8. A method according to claim 7, further comprising displaying at least one keyboard symbol and a corresponding voice tag name.

9. A method according to claim 7, further comprising switching off a microphone of the mobile communication terminal.

10. A computer program for answering silently a call with a mobile communication terminal, wherein the computer program comprises a play code, which is adapted in a silent mode to play a pre-recorded voice tag as a response to the caller, when said pre-recorded voice tag corresponding to a keyboard symbol of the mobile communication terminal is selected by the user during the call and the play code is run on the terminal.

11. A computer program according to claim 10, wherein the computer program further comprises an answer code, which is adapted to display keyboard symbols and corresponding tag names in the display of the mobile communication terminal, when it is run.

12. A computer program according to claim 11, wherein the answer code is further adapted to switch off a microphone of the mobile communication terminal, when the answer code is run on the mobile communication terminal.
